(19) United States
(12) Patent Application Publication
(10) Pub. No.: US 2015/0053832 A1
(43) Pub. Date: Feb. 26, 2015

(54) ADJUSTABLE OVER-THE-DOOR WREATH HANGER WITH IMPROVED RETENTION

(71) Applicant: Scott G. Williams, Pottsville, PA (US)

(72) Inventor: Scott G. Williams, Pottsville, PA (US)

(21) Appl. No.: 14/450,467

(22) Filed: Aug. 4, 2014

Related U.S. Application Data
(60) Provisional application No. 61/869,135, filed on Aug. 23, 2013.

(51) Int. Cl. A01G 5/04; F16M 13/02

(52) U.S. Cl. CPC A01G 5/04; F16M 13/022
USPC 248/205.2; 248/295.11; 29/428

(57) ABSTRACT

An adjustable wreath hanger includes an upper component that hooks over the upper edge of a door, a lower component that supports a decorative wreath, and a flexible elongation member that spans the upper and lower components. The components each include a plurality of slots through which the elongation member is threaded, with the slots including retention surfaces with frictional teeth to prevent inadvertent slippage of the elongation member through the slots. The lower component can be raised or lowered by adjusting the length of the flexible elongation member, thereby allowing a wreath to be hung high on a door, or low on a door.

### CROSS-REFERENCE TO RELATED APPLICATIONS

This application claims the benefit of U.S. Provisional Application 61/869,135, which was filed on Aug. 23, 2013.

### BACKGROUND OF THE INVENTION

The present invention relates to hanging hardware, and more specifically, to a decorative wreath hanger that secures to the uppermost edge of a structure such as a door or window.

Wreaths are very popular decorative items that are typically hung on the front door of a dwelling or business. Conventional wreath hangers are made of stiff materials such as metal or plastic which cause the wreath to protrude outwardly when the door has a window or moldings. In addition, adjustable hangers tend to be adjustable only to specific predetermined lengths. As a result, users aren't able to position a wreath exactly to their liking. Moreover, it is particularly difficult to hang a wreath on a door having a window, molding or other non-planar and/or fragile features.

Another issue with wreath hangers is that they are often not strong enough to hold a weighty wreath. Alternatively, the higher strength wreath holders tend to look like industrial hardware, thereby detracting from the aesthetics of the decorative wreath.

As can be seen, there is a need for a wreath hanger that allows a wreath to be hung at any location on a door without slippage. It is desirable that this hanger does not damage the door, and can be quickly installed, adjusted and removed. It is also desirable that the hanger does not introduce significant distance between the wreath and the door, so as not to detract from the aesthetic appeal of the decorative item.

### BRIEF DESCRIPTION OF THE DRAWINGS

FIG. 1 is a perspective view of an embodiment of the present invention;

FIGS. 2-7 depict various retention surfaces in exploded views;

FIG. 8 is a perspective view of a transparent embodiment of the present invention with the elongated member missing;

FIG. 9 is a perspective view of an opaque embodiment of the present invention with the elongated member missing; and

FIG. 10 depicts an embodiment of the device in use.

### SUMMARY OF THE INVENTION

An embodiment of the present invention includes an upper component that attaches to the upper edge of a door, a lower component that engages a decorative item such as a wreath, and an elongation member such as a ribbon that spans the upper component and lower component. The upper and lower components each define plurality of parallel horizontal slots through which the elongation member can be threaded in a variety of configurations. The slots include frictional retention surfaces that prevent the elongation member from undesirably sliding through the slots. The elongation member can be adjusted to allow the upper and lower components to be spaced one from another in a range of distances. For example, a small distance between the upper and lower component would result in a decorative item positioned relatively high on a door. Alternatively, a large distance between the upper and lower component would result in a decorative item positioned relatively low on a door. The present invention is not limited to doors, and could be used on windows and other structures having an upper surface that would secure the door hook portion of the upper component.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

As used herein, the following structure numbers shall apply to the various figures:

10—Hanger;

13—Door;

15—Wreath;

20—Upper component;

22—Upper slots;

24—Door hook:

26—First side;

27—Second side;

28—Third side;

30—Elongation member;

35—Protruding end;

40—Lower component;

42—Lower slots;

44—Wreath hook; and

50—Retention surface.

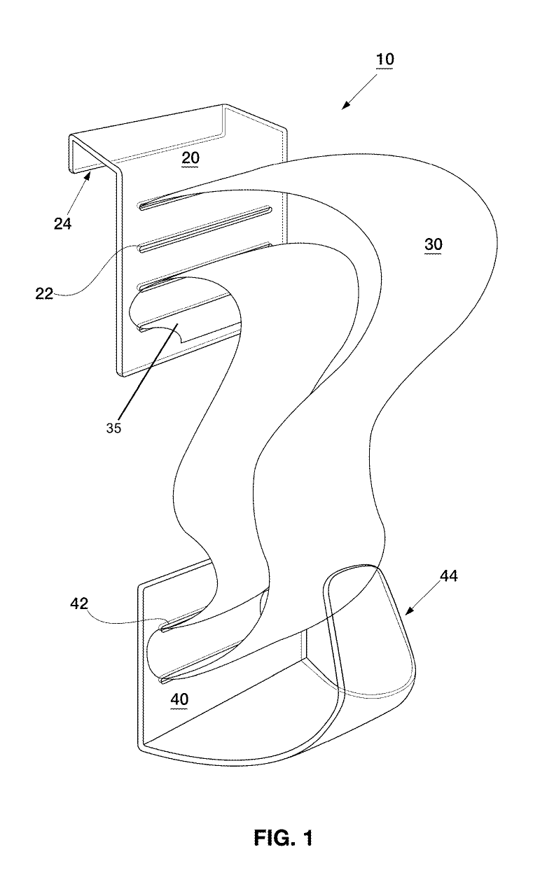

Broadly, an embodiment of the present invention provides a device for hanging decorative items, and particularly wreaths, on doors. Referring to FIG. 1, hanger 10 includes upper component 20 releasably connected to lower component 40 by elongation member 30. Elongation member 30 is preferably flexible, for example ribbon, and weaves in and out of upper slots 22 and lower slots 42. The distance between upper component 20 and lower component 40 can be adjusted by varying the length of the connecting segment of elongation member 30 there between. More specifically, pulling protruding end 35 of elongation member 30 brings upper and lower components closer together, and the reverse adds slack between upper and lower components so they hang further apart. In this manner, a wreath can be positioned anywhere on the surface of the door, limited only by the length of the elongation member. This is particularly desirable when the door includes features such as windows and moldings which dictate that the wreath must be hung in limited positions.

Upper component 20 preferably includes door hook 24 which snuggly but releasably fits to the uppermost edge of a standard door. In the most preferred embodiment first side 26 is smaller in perimeter and area than second side 27, which is smaller in perimeter and area than third side 28. The three sides preferably have similar widths, but different lengths, and are perpendicular one to another. Lower component 40 preferably includes wreath hook 44 which releasably retains a wreath. Elongation member 30 is preferably decorative ribbon, which complements the aesthetics of the wreath and/or door, having dimensions of approximately 1-6 feet long, and 0.5-5 inches wide.

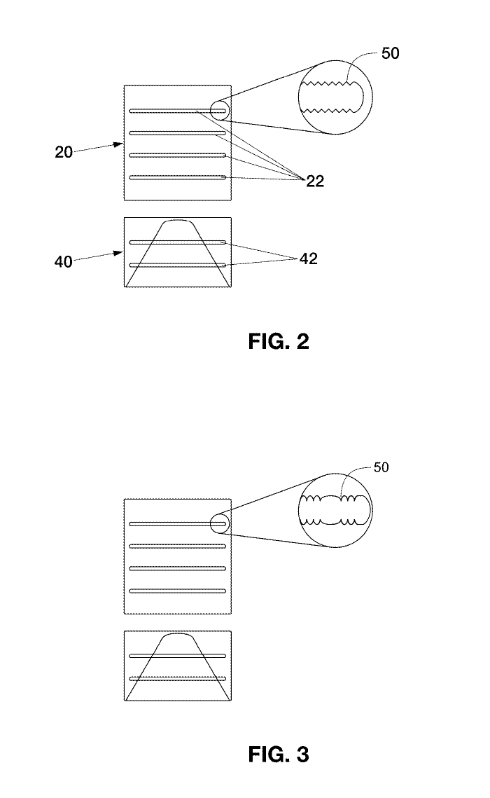

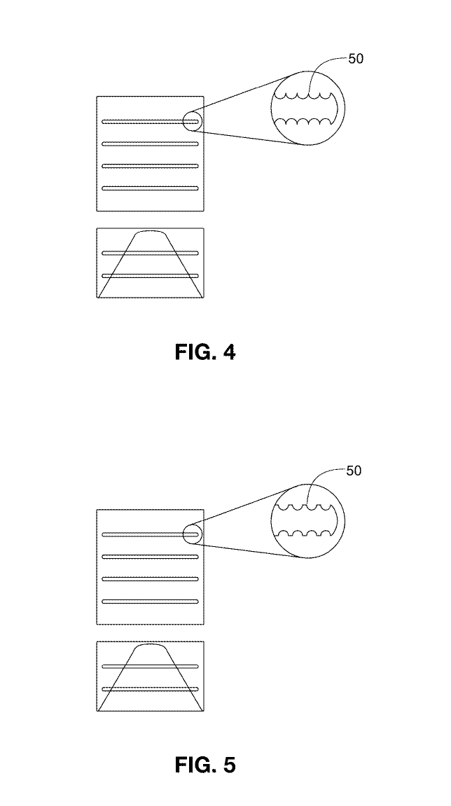

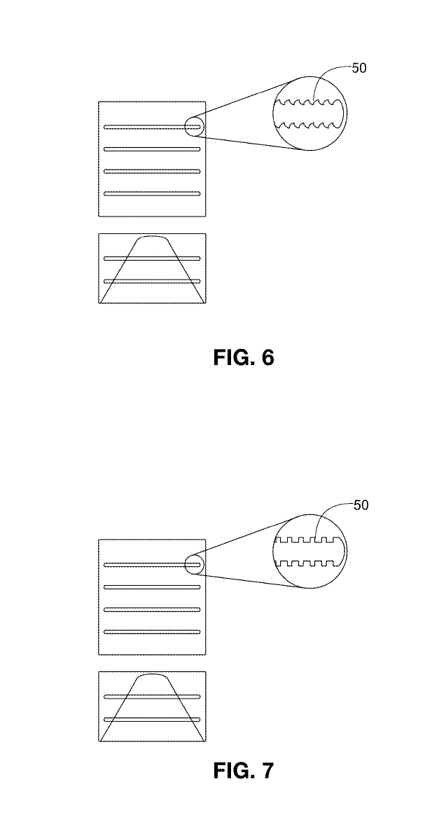

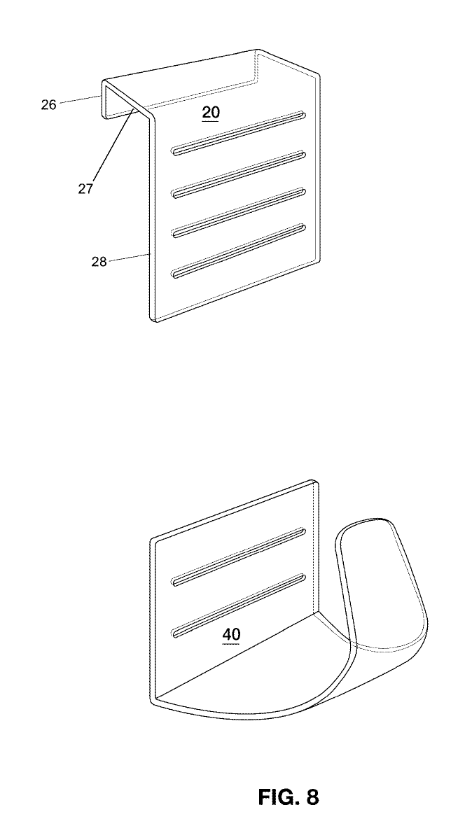

As set forth in FIGS. 2-7, it is desirable that retention surface 50 of upper slots 22 includes a plurality of teeth or other friction enhancing features to improve retention of elongation member 30 passing through slot. Although not shown, it is preferred that retention surface 50 of lower slots 42 likewise include friction enhancing features such as teeth. These teeth can be a variety of sizes and shapes, but it is desirable that friction enhancing features are very small, such that retention surface 50 appears smooth to the naked eye. In a preferred embodiment, the friction enhancing features are each approximately 0.0001-0.003 inches tall, and 0.00001-0.0001 inches wide.

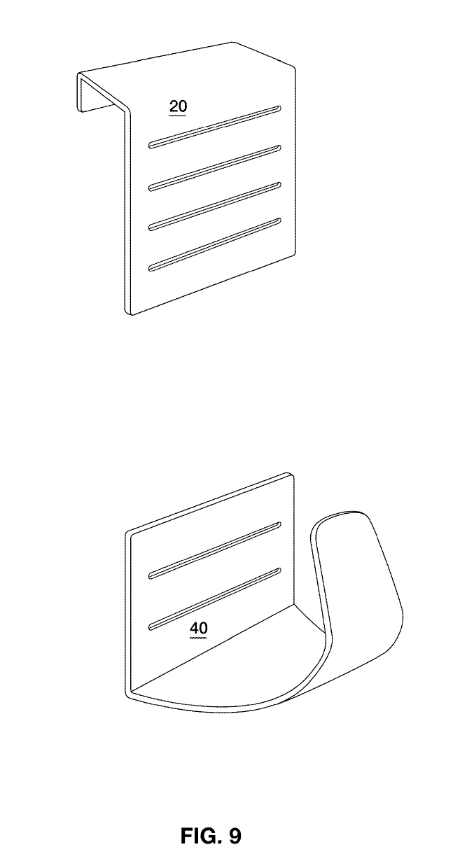

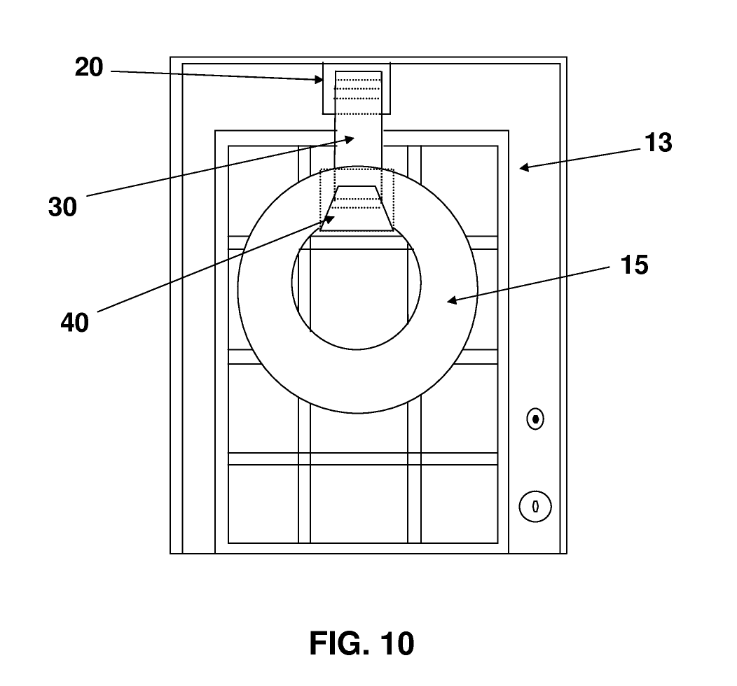

Hanger 10 can be constructed by known methods such as laser cutting, cutting, punching or casting of any suitable material such as polycarbonate or metal. It has been found that the preferred production method uses a multi-part die with a press. The device can be constructed of transparent or semi-transparent material, as shown in FIG. 8, or of opaque material, as shown in FIG. 9. The contours of upper and lower components 20, 40 can be introduced using methods known in the art.

In use, door hook 24 of upper component 20 is positioned over the uppermost edge of a door. It can be centered or not. Elongation member 30 is threaded through upper slots 22, and adjusted for overall length. Lower component 40 is threaded onto dangling elongation member 30 and adjusted to the desired height. Wreath 15 is placed on wreath hook 44.

It should be understood, of course, that the foregoing relates to exemplary embodiments of the invention and that modifications may be made without departing from the spirit and scope of the invention as set forth in the following claims. By way of example, upper component 20 can be modified in shape and/or size to allow fitting over other structures such as windows, molding, frames, and so forth. Also, lower component 40 can be modified in shape and/or size to hang items other than wreaths. Also, elongation member 30 can hold a wreath directly by tying, securing with loops, or the like, without lower component 40. It should also be understood that ranges of values set forth inherently include those values, as well as all increments between.

What is claimed is:

1. A hanger for a decorative item including:
A. A rigid upper component configured to fit over the uppermost edge of a door;
B. A plurality of slots defined by said upper component;
C. A non-smooth retention surface defined by said slots; and
D. A flexible elongation member threaded through said slots and in contact with said retention surface.

2. The hanger of claim 1 wherein said rigid upper component includes a first side, a second side and a third side.

3. The hanger of claim 2 wherein said first and second sides are substantially perpendicular.

4. The hanger of claim 3 wherein said second and third sides are substantially perpendicular.

5. The hanger of claim 2 wherein said first side, second side and third side have identical widths but different lengths.

6. The hanger of claim 1 wherein said plurality of slots consists of 2-4 slots.

7. A wreath hanger including:
A. A rigid upper component having 3 rectangular sides oriented perpendicularly one from another;
B. A plurality of slots defined by said upper component, said slots including a frictional retention surface;
C. A rigid lower component; and
D. A flexible elongation member releaseably engaged to said upper component and lower component.

8. The wreath hanger of claim 7 wherein said rigid lower component defines a hook.

9. The wreath hanger of claim 7 wherein said lower component defines a plurality of slots having a frictional retention surface.

10. The wreath hanger of claim 7 wherein said frictional retention surface includes a plurality of teeth.

11. The wreath hanger of claim 10 wherein said teeth are each approximately 0.0001-0.003 inches tall, and approximately 0.00001-0.0001 inches wide.

12. The wreath hanger of claim 7 wherein the distance between said upper component and lower component can be increased or decreased by adjusting said flexible elongation member.

13. The wreath hanger of claim 12 wherein said flexible elongation member releaseably engages said upper component by passing through at least two slots.

14. A method of hanging a decorative item including the steps of:
A. Releaseably engaging an upper component on a ledge;
B. Inserting an elongation member through at least two slots on said upper component, said slots including a plurality of frictional retention teeth;
C. Inserting said elongation member through at least two slots on a lower component, said slots including a plurality of frictional retention teeth;
D. Manipulating the elongation member to change the distance between said upper component and said lower component; and
E. Releaseably engaging a decorative item on said lower component.

15. The method of claim 14 wherein said step of releasably engaging an upper component on a ledge includes the step of engaging said upper component on the ledge of a structure selected from the group consisting of a door and a window.

16. The method of claim 14 wherein said step of releaseably engaging a decorative item on said lower component includes the step of hanging said decorative item on an upwardly projecting hook.

17. The method of claim 14 wherein said step of manipulating the elongation member to change the distance between said upper component and said lower component includes the step of lengthening or shortening the length of at least one protruding end.
